(19) United States
(12) Patent Application Publication
(10) Pub. No.: US 2011/0084426 A1
(43) Pub. Date: Apr. 14, 2011

(54) METHOD OF NOTCHING BRITTLE MATERIAL, METHOD OF MAKING MEMBER HAVING NOTCH, AND METHOD OF MAKING DISPLAY DEVICE

(75) Inventors: Tsubasa Nakamura, Machida-shi (JP); Yuji Matsuo, Machida-shi (JP)

(73) Assignee: CANON KABUSHIKI KAISHA, Tokyo (JP)

(21) Appl. No.: 12/901,307

(22) Filed: Oct. 8, 2010

(30) Foreign Application Priority Data
Oct. 13, 2009 (JP) 2009-236433
Sep. 15, 2010 (JP) 2010-206729

(51) Int. Cl. B29C 51/42

(52) U.S. Cl. 264/479

(57) ABSTRACT

A method of notching a brittle material includes forming a spot on a predetermined face of the brittle material by irradiating an area of the predetermined face with a light beam; and forming a notch in the brittle material by exfoliating a portion of the brittle material including the area from the brittle material by cooling a part of the brittle material including the area after the heating the brittle material, wherein a length of the area in an X direction of the predetermined face is smaller than a total length of the predetermined face in the X direction, and a length of the light beam spot in a Y direction of the predetermined face is equal to a total length of the predetermined face in the Y direction.

### BACKGROUND OF THE INVENTION

1. Field of the Invention

The present invention relates to a method of notching a brittle material, to a method of making a member having a notch, and a method of making a display device using the member having the notch.

2. Description of the Related Art

In a flat display device including a face plate and a rear plate that face each other, a spacer is disposed between the face plate and the rear plate. A brittle substance such as a glass or a ceramic is used as the spacer because of the mechanical strength (hardness) of glass and ceramic materials. Japanese Patent Laid-Open No. 6-342634 and Japanese Patent Laid-Open No. 2006-120534 disclose a spacer having a notch.

However, because a brittle substance is brittle, when a material (brittle material) made of a brittle substance is notched by performing contact machining such as cutting or grinding, the brittle material may break or chip, which may decrease the yield. Moreover, when notching is performed by grinding, dust is generated. If a spacer to which dust adheres is used for a display device that uses electron beams, such as a field emission display (FED), the dust may cause abnormal discharge.

Japanese Patent Laid-Open No. 2003-88989 describes a method of exfoliating a brittle material by forming a thermal distribution on a surface of the brittle material by irradiating the surface with a laser beam.

### SUMMARY OF THE INVENTION

It is difficult to form a notch having a good desired shape in a brittle material by performing non-contact machining by irradiating the brittle material with a laser beam even if the beam diameter of the laser beam is sufficiently small. The present invention provides a method of notching that is suitable for a brittle material and by which a notch having a good desired shape can be formed in the brittle material.

According to an aspect of the present invention, a method of notching a brittle material includes heating the brittle material by forming a light beam spot on a predetermined face of the brittle material by irradiating an area of the predetermined face with a light beam; and forming a notch in the brittle material by exfoliating a fraction of the brittle material including the area from the brittle material by cooling a portion of the brittle material including the area after the heating the brittle material, wherein a length of the area in a longitudinal direction of the predetermined face is smaller than a total length of the predetermined face in the longitudinal direction, and a length of the light beam spot in a lateral direction of the predetermined face is equal to a total length of the predetermined face in the lateral direction.

Further features of the present invention will become apparent from the following description of exemplary embodiments with reference to the attached drawings.

### BRIEF DESCRIPTION OF THE DRAWINGS

FIGS. 1A to 1D illustrate an example of an embodiment of to the present invention.

FIGS. 2A to 2H illustrate an example of an embodiment of to the present invention.

FIGS. 3A to 3H illustrate an example of an embodiment of to the present invention.

FIGS. 4A to 4F illustrate an example of an embodiment of to the present invention.

### DESCRIPTION OF THE EMBODIMENTS

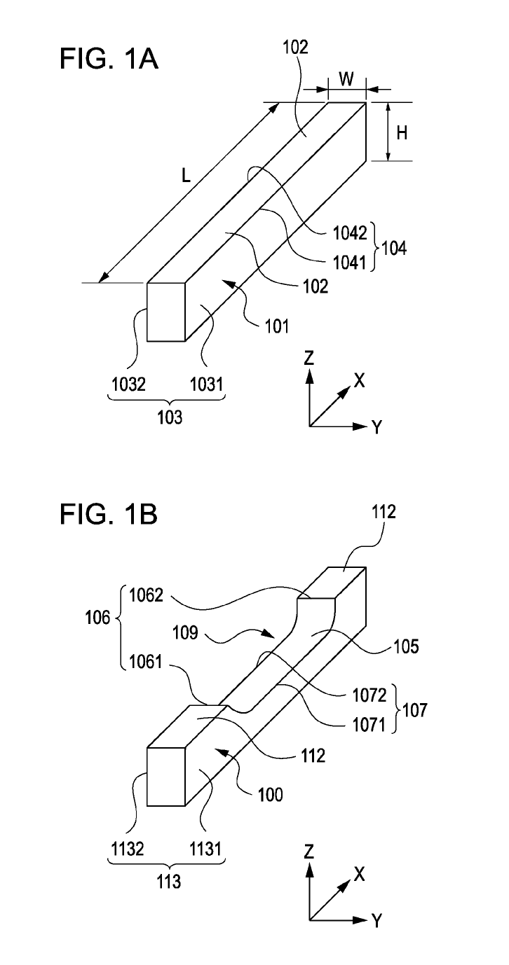

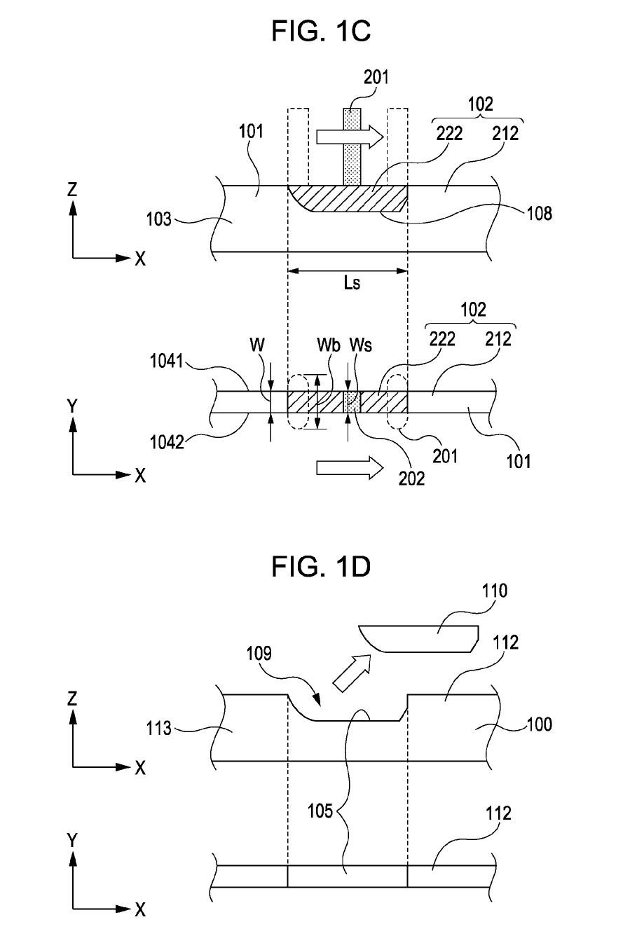

Referring to FIGS. 1A to 1D, an example of an embodiment of the present invention will be described. FIG. 1A illustrates a brittle material 101, which is a workpiece to be notched. FIG. 1B illustrates a brittle member 100, which is a product made by the notching. FIG. 1C illustrates a heating step of the notching. FIG. 1D illustrates a cooling step of the notching.

### Heating Step

The brittle material 101 illustrated in FIG. 1A is prepared as a workpiece. The brittle material 101 has a total length L in the X direction, a total length W in the Y direction, and a total length H in the Z direction. Hereinafter, the X direction, the Y direction, and the Z direction are regarded as the length direction, the width direction, and the height direction, respectively. Therefore, L denotes the length, W denotes the width, and H denotes the height of the brittle material 101, respectively. The length L, the width W, and the height H may be arbitrarily set. In the example described here, the length L is larger than the width W. That is, the brittle material 101 is a plate-shaped material having a length extending in the longitudinal direction and a width extending in the lateral direction. Moreover, in this example, the width W is smaller than the height H.

As illustrated in FIG. 1C, the brittle material 101 is irradiated with a light beam (beam 201) so as to form a light beam spot (spot 202) in an irradiation area 222 that is a part of a predetermined face 102. Hereinafter, one of the two faces of the brittle material 101 that extend in the X and Y directions (parallel to the XY plane) is assumed to be the predetermined face 102. As is clear from FIG. 1A, the predetermined face 102 extends in the X direction by the length L and extends in the Y direction by the width W. The total length of the brittle material 101 in a direction perpendicular to the predetermined face 102 (Z direction) corresponds to the height H.

The predetermined face 102 is irradiated with at least a part of the beam 201, which is one or more fluxes of light. The spot 202 is an irradiation portion of the beam 201 that is formed on the predetermined face 102 at the moment when the predetermined face 102, which is an image plane, is irradiated with the beam 201.

The spot 202 is not formed over the entire area of the predetermined face 102 in the X direction but in a partial area in the X direction. The irradiation area 222 is a part of the predetermined face 102 on which the spot 202 is formed, i.e., the area that is irradiated with the beam 201. Therefore, the irradiation area 222 has a length Ls in the X direction that is smaller than the length L of the predetermined face 102 of the brittle material 101. An unirradiated area 212 is an area of the predetermined face 102 excluding the irradiation area 222, i.e., an area that is not irradiated with the beam 201.

The spot 202 has a spot width Ws (length in the Y direction) that is equal to the width W of the predetermined face 102. Thus, the irradiation area 222 has a length in the Y direction that is equal to the width W of the predetermined face 102. This is achieved by making a beam width Wb, which is the length of the beam 201 that forms the spot 202 in the Y direction, be equal to or larger than the width W of the predetermined face 102.

By being irradiated with the beam 201, the temperature of the irradiation area 222 and the temperature of the vicinity of the irradiation area 222 are increased. Therefore, a high-temperature portion 108, which locally has a higher temperature than the surrounding area, is formed in the brittle material 101. The high-temperature portion 108 includes the irradiation area 222. The portion of the brittle material 101 excluding the high-temperature portion 108 will be referred to as a low-temperature portion. The low-temperature portion includes the unirradiated area 212 and has a lower temperature than the high-temperature portion 108. The increase in temperature is caused by absorption of the energy of the beam 201 by the brittle material 101. However, the high-temperature portion 108 is formed not only by the absorption of energy but also by heat conduction in the brittle material 101. Therefore, the range of the high-temperature portion 108 extends not only over the part of the brittle material 101 that is irradiated by the beam 201 but also to the surrounding area. In other words, the range of the high-temperature portion 108 can be controlled by appropriately setting the irradiation area 222 and the method of irradiation.

### Cooling Step

After irradiation with the beam 201 is finished, the part of the brittle material 101 including the irradiation area 222 is cooled. Alternatively, the entirety of the brittle material 101 may be cooled. As a result, as illustrated in FIG. 1D, a fraction of the brittle material 101 including the high-temperature portion 108 is exfoliated as an exfoliated piece 110, whereby a notch 109 is formed. The notch 109 is a portion defined by an exfoliated surface 105. FIG. 1B is a partial view of the brittle member 100 having the notch 109, which is a product. As can be seen from FIG. 1B, the notch 109 of the brittle member 100 is a recess that is formed in a part of the brittle member 100.

As heretofore described, notching is performed on the brittle material 101, which is a workpiece, through the heating step and the cooling step, whereby the brittle member 100 having the notch 109 is formed as a product. The exfoliated piece 110 may also be used as a product.

Hereinafter, an example of the present embodiment will be described in detail.

### Details of Brittle Material

The brittle material 101 will be described in detail. The brittle material 101 is not specifically limited, as long as the brittle material 101 can be broken and partially exfoliated by applying stress. For example, a glass; a crystal of quartz, sapphire, or silicon; a ceramics (sintered material), or a plastic can be used. In one embodiment, the heat conductivity of the brittle material 101 at 300 K be equal to or lower than 50 [W/(m·K)] and may be equal to or higher than 10 [W/(m·K)]. When using the brittle member 100 a spacer for a display device using electron beams as described below, the brittle material 101 can be an insulation material. However, when using a conductive material as the brittle material 101, the surface of the conductive material can be covered with an insulation film. As necessary, an electrically conductive film or a high-resistance film may be disposed on a surface of the brittle material 101. If the thickness of the film disposed on the surface is sufficiently smaller than the depth of the notch to be formed, the entire workpiece can be regarded as being brittle even if the film is not brittle. In one embodiment, the thickness of the film be equal to or smaller than 1/10 of the depth of the notch and may be equal to or smaller than 1/100 of the depth of the notch. If a film is formed on the predetermined face 102, the film is configured so as not to entirely reflect the beam 201. To be specific, the material and the thickness of the film are appropriately determined.

The predetermined face 102 on which the spot 202 is formed may be arbitrarily selected. When using the brittle member 100, which is a product, as a spacer described below, the length L of the predetermined face 102 can be larger than the width W. That is, the X direction can be the longitudinal direction and the Y direction can be the lateral direction.

As illustrated in FIG. 1A, the predetermined face 102 includes a first side edge 1041 and a second side edge 1042, which extend in the X direction, on the sides thereof in the Y direction. In other words, a direction in which the first side edge 1041 and the second side edge 1042 extend is the X direction. The first side edge 1041 and the second side edge 1042 will be collectively referred to as a side edge 104. The brittle material 101 includes a first side face 1031 and a second side face 1032. The first side face 1031 is one of the two surfaces of the brittle material 101 that extend in the X direction and in the Z direction (parallel to the XZ plane). The second side face 1032 is the other of the two surfaces. The first side face 1031 is continuous with the predetermined face 102 through the first side edge 1041. The second side face 1032 is continuous with the predetermined face 102 through the second side edge 1042.

The first side face 1031 and the second side face 1032 will be collectively referred to as a side face 103. The distance between the first side edge 1041 and the second side edge 1042 in the Y direction corresponds to the width W. In some cases, the side edge 104, which is the boundary between the predetermined face 102 and the side face 103, is not clear. In such a case, the side edge 104 is determined as follows: in an arbitrary YZ cross section of the brittle material 101, a tangential line (a first line) is drawn at a vertex of the predetermined face 102 in the Z direction; a second line having an angle of 135° on the brittle material 101 side with respect to the tangent line is drawn such that the second line contacts to a surface of the brittle material 101; a tangent point of the second line and the surface of the brittle material 101 is obtained; and the tangent points for all YZ cross sections of the brittle material 101 are connected in the X direction to obtain the side edge 104. One of the two surfaces of the brittle material 101 that extend in the X direction and in the Y direction (parallel to the XY plane) and that is not the predetermined face 102 will be referred to as an opposite face.

In FIG. 1A, the brittle material 101 is rectangular-parallelepiped-shaped, the predetermined face 102 is rectangular, and the longitudinal direction is perpendicular to the lateral direction. However, the embodiment is not limited thereto. For example, at least one of the first side edge 1041 and the second side edge 1042 may be curved instead of being straight. The first side edge 1041 and the second side edge 1042 may not be parallel to each other. The cross-sectional shape in the YZ direction is not limited to a rectangle, and may be a general polygon.

If the predetermined face 102 is not rectangular, for example, a direction in which the first side edge 1041 extends is determined as the length direction, and a direction from an arbitrary point on the first side edge 1041 to an arbitrary point on the second side edge 1042 is determined as the width direction. The distance between an arbitrary point on the first side edge 1041 and an arbitrary point on the second side edge 1042 is determined as the width W. Even if the width W of the brittle material 101 is not uniform in the length direction, the distance between the arbitrary point on the first side edge 1041 and the arbitrary point on the second side edge 1042 corresponds to the width W. In practice, the width W is in the range from 50 μm to 5 mm. In one embodiment, the width W be equal to or smaller than 3 mm and may be equal to or smaller than 1 mm.

### Details of Heating Step

A light source that emits the beam 201 can have an output wavelength that is fit for the heat absorption spectrum of the brittle material 101.

As described above, the temperature of the brittle material 101 increases when the energy of the beam 201 is absorbed by the brittle material 101. The absorbed energy is converted to heat, which heats up the brittle material 101. Therefore, the wavelength of the light can be in the range in which the energy of the light is easily converted to heat. Infrared radiation (wavelength in the range from 0.7 μm to 1 mm) can be typically used.

The wavelength of the light can be in the range in which the light is easily absorbed by the brittle material 101. On the contrary, if the wavelength of the light is in the range in which the light is not absorbed by the brittle material 101 at all, the brittle material 101 is not heated. If the wavelength of the light is in the range in which the light is absorbed by the brittle material 101 only by a small amount, heat conduction occurs in the brittle material 101 before the brittle material 101 is sufficiently heated, so that it is difficult to generate a clear temperature difference between the high-temperature portion 108 and the low-temperature portion.

For example, a quartz glass having a thickness of 2 mm has a high light transmittance that is higher than 90% (a low light absorptance) with respect to light having a wavelength in the range from about 0.3 to 2 μm. In contrast, if the wavelength of light is equal to or larger than 3 μm, the light transmittance substantially decreases. The quartz glass has a low light transmittance lower than 20% (a high light absorptance) with respect to light having a wavelength equal to or larger than 4 μm. The light transmittance of the quartz glass with respect to light having a wavelength in the range from 2 to 3 μm considerably differs depending on whether or not a hydroxyl radical is present in the quartz glass. The absorption spectrum differs in accordance with the type of the brittle material 101 (for example, silicate glass includes types such as a quartz glass, a borosilicate, a soda lime glass, etc.). The absorption spectrum differs in accordance with the amount and the type of impurity contained in the substance.

The relationship between the brittle material 101 and the absorption of the beam 201 can be represented by the absorption constant with respect to the wavelength of the beam 201. In practice, the absorption constant of the brittle material 101 can be equal to or higher than 20. In one embodiment, the absorption constant of the brittle material 101 be equal to or higher than 150 and may be equal to or higher than 1000. In general, the longer the wavelength of infrared radiation, the higher the absorption constant. If the wavelength of light is equal to or larger than 4 μm, a general silicate glass described above has an absorption constant that is equal to or higher than 150. A quartz glass has an absorption constant of about 350 with respect to light having a wavelength of 4 μm. The wavelength of the light may be equal to or larger than 4.5 μm.

A laser beam can be used as the beam 201 because a high output power can be easily obtained and an optical system can be easily designed. The laser light source may be a pulse laser, which outputs laser light as a pulse wave, or a continuous wave (CW) laser, which outputs laser light a continuous wave. The laser light source may be a solid-state laser, a gas laser, or a semiconductor laser. Examples of the solid-state laser include a YAG laser, a ruby laser, etc. The YAG laser can be used because the use of infrared radiation is effective as described above. In particular, an Er:YAG laser (wavelength of about 3 μm), which has a larger wavelength than an Nd:YAG laser (wavelength of about 1 μm), can be used. Examples of the gas laser include a CO₂ laser (wavelength in the range from 9 to 11 μm), a CO laser (wavelength from 5 to 7 μm), a He—Ne laser, an excimer laser, etc. A CO₂ laser or a CO laser can be used, because the use of infrared radiation is effective as described above. In particular, a CO₂ laser can be used.

However, the light may not be coherent in order to heat the brittle material 101, as long as the light has a certain degree of directivity so as to allow local irradiation. Instead of using laser light, for example, the beam 201 can be formed by using a lamp that emits light in random directions and a mask having an opening so that the light passes through the opening in a specific direction. As the lamp, an infrared radiation lamp, such as a halogen lamp, can be used.

The beam 201 is determined as a part of the flux of light having an energy intensity that is equal to or higher than 13.5% of the maximum value of the energy intensity distribution of the flux of light in the cross section of the flux of light on the predetermined face 102. Therefore, the range of the beam 201 for defining the width Wb of the beam 201 and the like is determined as the part having an energy intensity that is 13.5% of the maximum value of the energy intensity distribution. Thus, naturally, the energy intensity in the spot 202 is equal to or higher than 13.5% of the maximum value of the energy intensity distribution of the beam 201. This is because, even if the predetermined face 102 is irradiated with a part of the light beam having an energy intensity that is lower than 13.5% of the energy distribution of the flux of light in the cross section of the flux of light, such irradiation does not substantially contribute to heating of the brittle material 101. The maximum value may be determined in accordance with the wavelength of the light beam, the heat absorption spectrum and the heat conductivity of the brittle material 101, and the shape of the notch 109 to be formed. The maximum value of the intensity of the beam 201 may be determined so that an energy intensity that is 13.5% of the maximum value can heat the brittle material 101 to a degree that is sufficient for exfoliating a fraction of the brittle material 101.

The length Ls of the irradiation area 222 in the X direction may be the same as the length of the spot 202 in the X direction. However, the length Ls of the irradiation area 222 in the X direction can be controlled by scanning the control spot 202 in the X direction. When the spot 202 is not scanned, the area and the shape of the irradiation area 222 are the same as those of the spot 202. When the spot 202 is scanned, the area of the irradiation area 222 is larger than that of the spot 202. In other words, if the length of the spot 202 in the X direction is smaller than the length Ls of the irradiation area 222 in the X direction, the spot 202 is scanned in the X direction. By scanning the spot 202 in the X direction, even if the length Ls in the X direction is large, the spot 202 can be provided with a desired energy density without considerably increasing the output power of the laser. In one embodiment, t<Ls²/4α, where t [s] is the time interval between the time when the spot 202 that forms one of the edges of the irradiation area 222 that intersect the X direction is formed and the time when the spot 202 that forms the other of the edges is formed; α [m²/s]=λ/ρCₚ is the thermal diffusivity of the brittle material 101, where λ [W/(m·K)] is the heat conductivity of the brittle material 101, ρ [kg/m³] is the density of the brittle material 101, and Cₚ [J/(kg·K)] is the specific heat capacity of the brittle material 101; and Ls [m] is the length of the irradiation area 222 in the X direction. When the spot 202 is scanned in one of the X directions from one of the edges to the other of the edges, the scanning speed V [m/s] of the spot 202 satisfies V≦4α/Ls. The edges of the irradiation area 222 that intersect the X direction are the edges of the irradiation area 222 that are not the side edge 104 and generally correspond to a first end ridge 1061 and a second end ridge 1062 as described below. By scanning the spot 202 in this manner, the edge of the high-temperature portion 108 can be made clear, whereby a notch having a good shape can be formed. Regarding the shapes of the brittle material 101 and the irradiation area 222, if Ls>W and/or H>W is satisfied, the edge of the high-temperature portion 108 can be made clear, whereby a notch having a good shape can be formed.

The spot 202 can be scanned by moving the spot 202 relative to the predetermined face 102 of the brittle material 101. To be specific, the spot 202 is formed on the predetermined face 102 by irradiating a start point of the irradiation area 222 of the predetermined face 102 with the beam 201. Next, the spot 202 is scanned toward an end point of the irradiation area 222. The scanning may be performed by moving the light source, by scanning the beam 201 using an optical system, or by moving the brittle material 101. The beam 201 can be scanned, because, with this method, the precision of the spot width Ws, the uniformity of the incident angle of the beam 201, and the scanning speed can be achieved to a certain degree. To be specific, a light beam can be reflected by a galvano mirror or a polygon mirror, focused by a focusing lens, and the beam 201 can be scanned by driving the galvano mirror or the polygon mirror. By using a laser, which has a rapid ON/OFF response, as the light source of the beam 201, the irradiation area 222 can be clearly defined. In contrast, a general lamp has a slow ON/OFF response. Therefore, when a lamp is used as the light source, a shutter for switching between blocking and passing of the beam 201 can be disposed on the optical path. The beam 201 is a beam that determines the energy intensity and the energy distribution in the spot 202. If the beam passes through or is reflected by a plurality of optical elements, the beam 201 is the beam that has passed through one of the optical elements in the last stage. As necessary, the beam 201 may be scanned also in the Y direction. Even when the beam 201 is scanned in the Y direction, the beam width Wb is determined to be equal to or larger than the width W of the predetermined face 102, so that the spot width Ws becomes the same as the width W of the predetermined face 102 while the scanning in the Y direction is being performed.

The spot width Ws the spot 202, which is the length in the Y direction, is the same as the width W of the predetermined face 102. In other words, the spot 202 is formed so as to extend from the first side edge 1041 to the second side edge 1042 of the brittle material 101. That is, the spot 202 is formed also on the first side edge 1041 and on the second side edge 1042. The position of the spot 202 on the first side edge 1041 and the position of the spot 202 on the second side edge 1042 may not be on a straight line extending in the Y direction. The beam width Wb, which is the length of the beam 201 that forms the spot 202 in the Y direction, can be larger than the width W of the predetermined face 102, i.e., the spot width Ws of the spot 202. By making the width Wb of the beam 201 be larger than the width W of the predetermined face 102, the spot width Ws of the spot 202 can be made to be the same as the width W of the predetermined face 102. Therefore, the yield can be increased. This is effective when scanning the spot 202. In contrast, if the width Wb of the beam 201 is too large, the energy intensity per unit area (energy density) of the spot 202 decreases and thereby the efficiency decreases. Therefore, in practice, the beam width Wb of the beam 201 may be equal to or smaller than 120% of the width W of the predetermined face 102 and may be equal to or smaller than 110% of the width W. If the width W of the predetermined face 102 in the irradiation area 222 is not uniform in the X direction, the beam width Wb is determined so that the beam width Wb be equal to or larger than the maximum value of the width W or so that the spot width Ws of the spot 202 does not become smaller than the width W of the predetermined face 102 by dynamically changing the beam width Wb during scanning. The spot width Ws of the spot 202 can be measured by using a sensor (for example infrared radiation sensor) adapted to the wavelength of the beam 201.

The irradiation angle of the beam 201 may be arbitrarily determined. However, if the energy intensity distribution in the beam 201 when the laser is output and the energy intensity distribution in the spot 202 formed on the predetermined face 102 have a simple correspondence, the shape of the notch 109 can be easily controlled. In one embodiment, the irradiation angle of the beam 201 with respect to the predetermined face 102 be in the range from 75° to 105° and may be 90°.

The range of the high-temperature portion 108 is correlated with the shape of the notch 109. As described above, the increase in temperature is caused by the absorption of the beam 201 by the brittle material 101. However, the high-temperature portion 108 is formed not only by the absorption but also by the heat conduction in the brittle material 101. Therefore, the high-temperature portion 108 ranges not only over a region of the brittle material 101 through which the beam 201 passed but also to the vicinity of the region. Therefore, the range of the high-temperature portion 108 depends on the heat conductivity of the brittle material 101. The range of the high-temperature portion 108 in the X direction and the Y direction approximately corresponds to the irradiation area 222. However, the range in the Z direction is depends on the energy intensity of the beam 201. As will be described below in detail, the notch 109 having various shapes can be obtained by controlling the beam 201 in the method according to the present invention.

The temperature of the high-temperature portion 108 is higher than at least the temperature of the unirradiated area 212 of the brittle material 101. The temperature can be high so that the high-temperature portion 108 can be melted. That is, the temperature of the high-temperature portion 108 can be equal to or higher than the melting point of the brittle material 101. Although general brittle materials, such as glass, do not usually have a clear melting point, the temperature of the high-temperature portion 108 can be equal to or higher than the glass transition temperature.

### Details of Cooling Step

The high-temperature portion 108, which has been irradiated with the beam 201, is cooled in the cooling step. As a result, the high-temperature portion 108 contracts and a residual stress is generated, whereby a crack is generated in the vicinity of the high-temperature portion 108. As the crack grows, a part of the brittle material 101 including the high-temperature portion 108 is exfoliated as the exfoliated piece 110. By making the width Ws of the spot be the same as the width W of the predetermined face 102 of the brittle material 101 in heating step, a boundary point is generated between the high-temperature portion 108 and the low-temperature portion on the side edge 104 of the brittle material 101. To be specific, four boundary points, including two boundary points that are in the vicinity of the boundaries between the irradiation area 222 and the unirradiated area 212 on the first side edge 1041 and two boundary points that are in the vicinity of the boundaries between the irradiation area 222 and the unirradiated area 212 on the second side edge 1042. Cracks originate at the boundary points, and the boundary points define the exfoliated surface 105. The origins of the cracks are usually located in the unirradiated area 212.

When the temperature slowly decreases, as in the case of natural cooling in room temperature atmosphere, the residual stress is relieved before the high-temperature portion 108 is cooled, so that generation of cracks may be impeded. Therefore, in the cooling step, the high-temperature portion 108 can be rapidly (forcedly) cooled so as to increase the probability of generation of cracks and increase the yield. Examples of the method of rapid cooling include air cooling in a low temperature atmosphere, wind cooling, water cooling, and liquid cooling. In particular, a coolant, such as dry ice or liquid nitrogen, can be used. In order to accelerate cooling, the entire brittle material 101 or the vicinity of the irradiation area 222 may be cooled before irradiating the brittle material 101 with the beam 201.

### Details of Brittle Member

The brittle member 100, which is made by using the present embodiment, will be described. As illustrated in FIG. 1B, the brittle member 100 has the first end ridge 1061 and the second end ridge 1062, which extend in the Y direction, on the sides in the X direction. The first end ridge 1061 and the second end ridge 1062 will correlatively referred to as an end ridge 106. The brittle member 100 has a first side ridge 1071 and a second side ridge 1072, which extend in the XZ plane, on the sides in the Y direction. The first side ridge 1071 and the second side ridge 1072 will be collectively referred to as a side ridge 107. The exfoliated surface 105 is a surface surrounded by the end ridge 106 and the side ridge 107. The end ridge 106 corresponds to a part of the predetermined face 102 of the brittle material 101. The side ridge 107 corresponds to a part of the side face 103 of the brittle material 101.

The brittle member 100 includes a first unexfoliated side face 1131 and a second unexfoliated side face 1132. The first unexfoliated side face 1131 is one of the two surfaces (parallel to the XZ plane) of the brittle member 100 that extend in the X direction and in the Z direction. The second unexfoliated side face 1132 is the other of the two surfaces. The first unexfoliated side face 1131 and the second unexfoliated side face 1132 will be collectively referred to as an unexfoliated side face 113.

The unexfoliated side face 113 is a surface that is continuous with the exfoliated surface 105 through the side ridge 107 and corresponds to a part of the side face 103 of the brittle material 101. An unexfoliated predetermined face 112 is a surface that is continuous with the exfoliated surface 105 through the end ridge 106 and corresponds to a part of the predetermined face 102 of the brittle material 101. The unexfoliated predetermined face 112 includes at least the unirradiated area 212 in the heating step.

Thus, the notch 109 according to the present embodiment has a shape formed by removing a part of the side face 103 (a part of the first side face 1031 and a part of the second side face 1032) and a part of the predetermined face 102 from the brittle material 101. The unexfoliated side face 113 of the brittle member 100 has an opening. That is, the notch 109 in the present embodiment does not have a shape (so-called caved shape) that is formed by removing only a part of the predetermined face 102 of the brittle material 101 without removing the side face 103 of the brittle material 101. The notch 109 does not have a shape that is formed by removing only a part of the first side face 1031 of the brittle material 101 and a part of the predetermined face 102 without removing the second side face 1032 of the brittle material 101.

In the brittle member 100 made by using the present embodiment, the end ridge 106 and the side ridge 107 of the exfoliated surface 105 are clear. Moreover, the exfoliated surface 105, which defines the notch 109, is very smooth. Burrs and projections are not generated in a region surrounding the notch 109. With the exception of the exfoliated piece 110, dust or the like are not generated by a large amount. The internal stress of the brittle member 100 is not increased by forming the notch 109, so that the brittle member 100 is not easily broken by an external force. Therefore, as described below in detail, the brittle member 100 is suitable for use as a member (spacer) that is disposed between two members, such as the face plate and the rear plate of a flat panel display (FPD), in order to define the distance between the two members. The method of notching a brittle material according to the present invention can be used to make not only the spacer but also to process a substrate of the face plate and the rear plate, which is made of a glass or the like (for example, to process an end surface of such a member). Moreover, the method can be used to produce a member that is made of glass or ceramics and that is used for products other than a display device (for example, building materials and mechanical components).

Hereinafter, embodiments will be further described.

### Prevention of Recurving

The brittle material 101 may be easily recurved during notching when, as illustrated in FIG. 1A, the brittle material 101 is plate-shaped, the length L is larger than the width W, the X direction is the longitudinal direction, and the Y direction is the lateral direction. In particular, the situation of recurving is serious when the length L of the brittle material 101 is considerably larger than the height H.

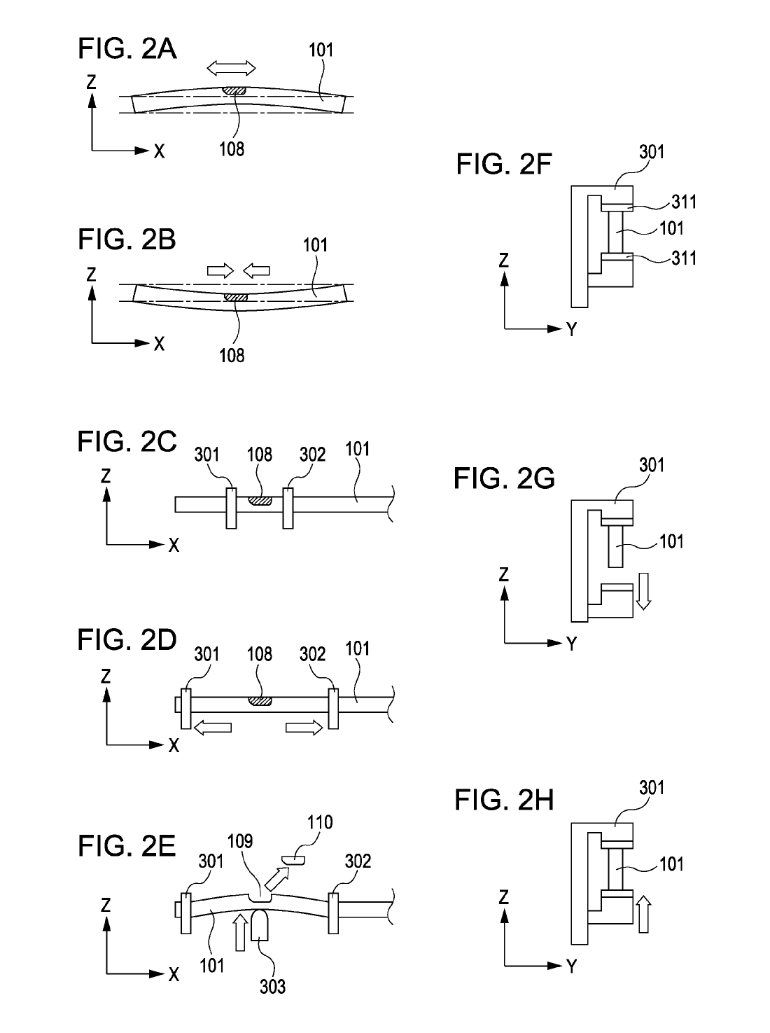

FIGS. 2A and 2B are side views of the brittle material 101 that is being notched. As illustrated in FIG. 2A, in the heating step (during laser irradiation), a stress indicated by an arrow is generated due to expansion of the high-temperature portion 108, and the predetermined face 102 of the brittle material 101 may be recurved about an axis extending in the Y direction to have a convex shape around the irradiation area 222. As illustrated in FIG. 2B, in the cooling step, a stress indicated by arrows is generated due to contraction of the high-temperature portion 108, and the predetermined face 102 of the brittle material 101 may be recurved about an axis extending in the Y direction to have a concave shape around the irradiation area 222. In the FIGS. 2A and 2B, the alternate-long-and-short-dash-line illustrates the positions of the predetermined face 102 and the opposite face when the recurving does not occur.

Such recurving may cause defocus or displacement of the beam 201 and may considerably reduce the precision of the method. Moreover, the brittle member 100 may be recurved. Thus, the notching can be performed while suppressing the recurving of the brittle material 101 due to the expansion or the contraction of the brittle material 101.

To be specific, at least the heating step is performed while fixing at least two positions of the unirradiated area 212, the two positions being located on two sides of the irradiation area 222 of the predetermined face 102 of the brittle material 101 in the X direction. In other words, a portion of the predetermined face 102 of the brittle material 101 between the two fixed positions is irradiated with the beam 201. Devices that fix at least the two positions on the two sides of the irradiation area 222 of the brittle material 101 will be referred to as recurving limitation devices. The term “fix” means to immobilize, and it is not necessary that the two positions of the predetermined face 102 directly contact the recurving limitation devices.

The recurving limitation devices are not limited specific devices, as long as the recurving limitation devices can suppress the recurving of the brittle material 101. For example, a first fixing jig 301 fixes a position in the −X direction of the irradiation area 222, and a second fixing jig 302 fixes a position in the +X direction of the irradiation area 222.

For example, the brittle material 101 may be clamped from the side face 103 by pressing the brittle material 101 from the first side face 1031 and from the second side face 1032 of the brittle material 101 using the first fixing jig 301. Alternatively, the brittle material 101 may be clamped from the predetermined face 102 by pressing the brittle material 101 from the predetermined face 102 of the brittle material and from the opposite face of the brittle material 101 using the first fixing jig 301. The same method can be used for the second fixing jig 302. The first fixing jig 301 and the second fixing jig 302 are fixed to a rigid body. A tension may be applied in the X direction between the first fixing jig 301 and the second fixing jig 302.

The method of clamping the brittle material 101 from the side face 103 suppresses recurving by using friction between the first fixing jig 301 and the side face 103 and friction between the second fixing jig 302 and the side face 103. Therefore, if a fixing jig slips over the brittle material 101, the side face 103 of the brittle material 101 may be scratched. With consideration of the combination with a counter-warping mechanism described below, the method of clamping the predetermined face 102 can be used. In order to prevent the brittle material 101 from being scratched, a soft member can be disposed at contact portions 311 between the first fixing jig 301 and the brittle material 101 and between the second fixing jig 302 and the brittle material 101.

In order to reduce the pressure applied to the predetermined face of the brittle material 101, the lengths (in the X direction) of the contact portions 311 between the brittle material 101 and the first fixing jig 301 and between the brittle material 101 and the second fixing jig 302 can be as long as possible.

In order to suppress warping as much as possible, the distance between the jigs can be as small as possible provided that the beam 201 is not blocked. However, if the distance between the first fixing jig 301 and the second fixing jig 302 is small, when the brittle material 101 is irradiated with the beam 201 and heated, the temperatures of the first fixing jig 301 and the second fixing jig 302 may be increased. Therefore, the contact portions 311, which are disposed between the brittle material 101 and the first fixing jig 301 and between the brittle material 101 and the second fixing jig 302, can be heat resistant. For the reasons described above, the contact portions 311, which are between the brittle material 101 and the fixing jigs, can be heat resistant and soft. Examples of such materials include heat resistant plastics such as PPS resin and PEEK resin.

In order to increase probability of exfoliation and increase the yield during cooling or after cooling, another step of for increasing a residual stress can be performed in addition to the cooling step. To be specific, a bending stress is applied to the brittle material 101 so that the predetermined face 102 of the brittle material 101 is warped to have a convex shape in a counter-warping direction that is counter to the direction in which the brittle material 101 is warped due to contraction of the high-temperature portion 108 as illustrated in FIG. 2B. Thus, the stress at the boundary between the high-temperature portion 108 and the low-temperature portion is increased, whereby the probability of generation of cracks is increased. The bending stress can be applied so as to recover the original shape of the entirety of the brittle material 101. At this time, it is not necessary that the predetermined face 102 be actually warped in a convex shape. When the cooling step is performed while fixing the at least two positions of the unirradiated area 212 on the two sides of irradiation area 222 in the X direction, a bending stress is applied in the counter-warping direction that is counter to the direction of warping caused by contraction.

Moreover, as illustrated in FIG. 2E, a pressing force can be applied to a position between the first fixing jig 301 and the second fixing jig 302 from the side opposite to the irradiation area 222, i.e., from the opposite face by using an opposite-direction warping jig 303. Alternatively, at least one of the first fixing jig 301 and the second fixing jig 302 may be moved so as to warp the brittle material 101 in the counter-warping direction.

In order to apply a bending stress by as small a force as possible, the bending stress can be applied after irradiating the brittle material 101 with the beam 201 and increasing the distance between the first fixing jig 301 and the second fixing jig 302. For example, as illustrated in FIG. 2D, the first fixing jig 301 is moved in the −X direction, and the second fixing jig 302 is moved in the +X direction. In this case, the first fixing jig 301 (second fixing jig 302), which has been tightened to hold the brittle material 101 during laser irradiation as illustrated in FIG. 2F, is temporarily loosened and moved as illustrated in FIG. 2G, and tightened again as illustrated FIG. 2H.

### Shape of Notch

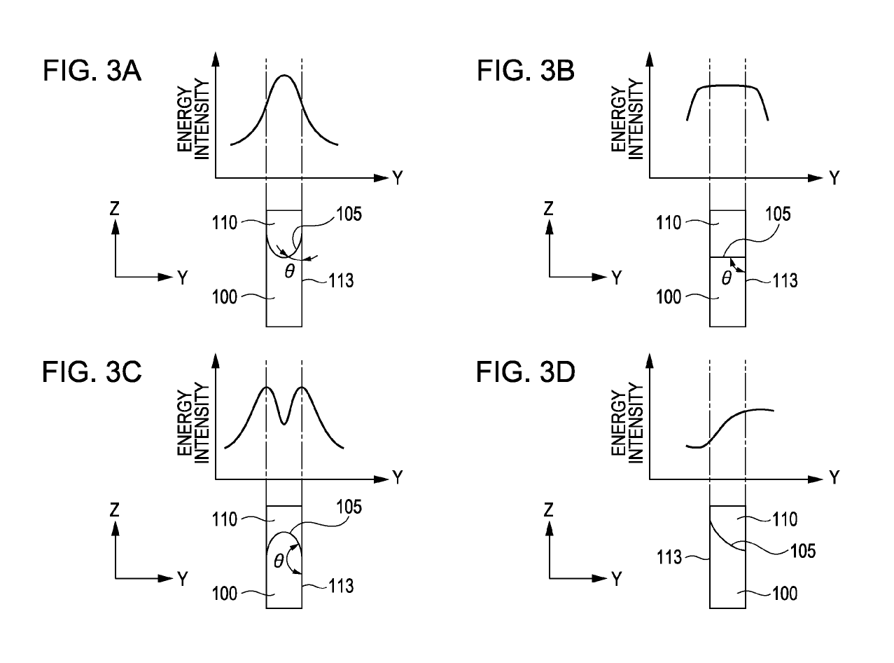

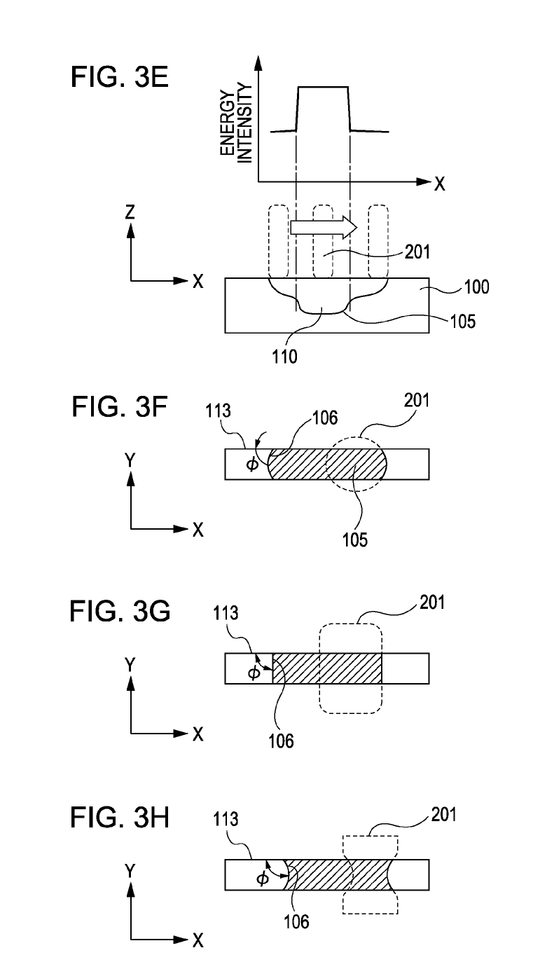

Referring to FIGS. 3A to 3H, control of the shape of the notch 109 will be described. FIGS. 3A to 3D illustrate examples of the relationship between the energy intensity distribution in the spot 202 and the shape of the notch 109 in the YZ cross section. The energy intensity distribution in a laser beam as a typical light beam is a Gaussian distribution having the maximum at the center. If the energy intensity distribution in the spot 202 is a distribution having the maximum at the center as illustrated in FIG. 3A, the angle θ between the exfoliated surface 105 and the unexfoliated side face 113 of the brittle member 100 is an acute angle. If the energy intensity distribution in the spot 202 is a uniform distribution as illustrated in FIG. 3B, the angle θ between the exfoliated surface 105 of the brittle member 100 and the unexfoliated side face 113 of the brittle member 100 is close to a right angle. As long as the difference between the maximum value and the minimum value of the energy intensity distribution in the spot 202 is equal to or smaller than 10% of the maximum value, the distribution can be regarded as a uniform distribution. The difference can be equal to or smaller than 5%. If the energy intensity distribution in the spot 202 has the minimum at the center as illustrated in FIG. 3C, the angle θ between the exfoliated surface 105 and the unexfoliated side face 113 of the brittle member 100 is an obtuse angle. If the energy intensity distribution in the spot 202 has the minimum at one side and the maximum at the other side as illustrated in FIG. 3D, one of the angles between the exfoliated surface 105 and the unexfoliated side face 113 of the brittle member 100 is an acute angle and the other of the angles is an obtuse angle.

Thus, by changing the energy intensity distribution in the spot 202, the shape of the notch 109 in the YZ direction can be controlled.

As illustrated in FIG. 3E, by dynamically changing the output power of the laser while the beam 201 is being scanned in the X direction, the distribution of the depth of the notch 109 in the X direction can be controlled.

FIGS. 3F to 3H are plan views parallel to the XY plane illustrating the relationship between the shape of the spot 202 and the shape of the notch 109. In FIGS. 3F to 3H, the dotted line represents the shape of the spot 202 formed on the predetermined face 102 of the brittle material 101. If the brittle material 101 is irradiated with the spot 202 having a circular shape as illustrated in FIG. 3F, the angle φ between the end ridge 106 and the unexfoliated side face 113 of the brittle member 100 is an acute angle. If the brittle material 101 is irradiated with the spot 202 having a rectangular shape as illustrated in FIG. 3G, the angle φ between the end ridge 106 and the unexfoliated side face 113 of the brittle member 100 is close to a right angle. If the brittle material 101 is irradiated with the spot 202 having an hourglass shape as illustrated in FIG. 3H, the angle φ between the end ridge 106 and the unexfoliated side face 113 of the brittle member 100 is an obtuse angle. If the spot 202 is likely to deviate in the Y direction during notching, the shape of the spot 202 can be linear with respect to the Y direction as illustrated in FIG. 3G so that the shape of the notch can be made uniform.

Thus, by changing the shape of the spot 202, the shape of the notch 109 in the XY direction can be controlled.

### Display Device

As described above, the brittle member 100 having the notch 109 is suitable for use as a spacer of a flat panel display (FPD). In particular, the brittle member 100 is suitable for use as a spacer of a field emission display (FED) including electron-emitting devices and a fluorescent film and using electron beams.

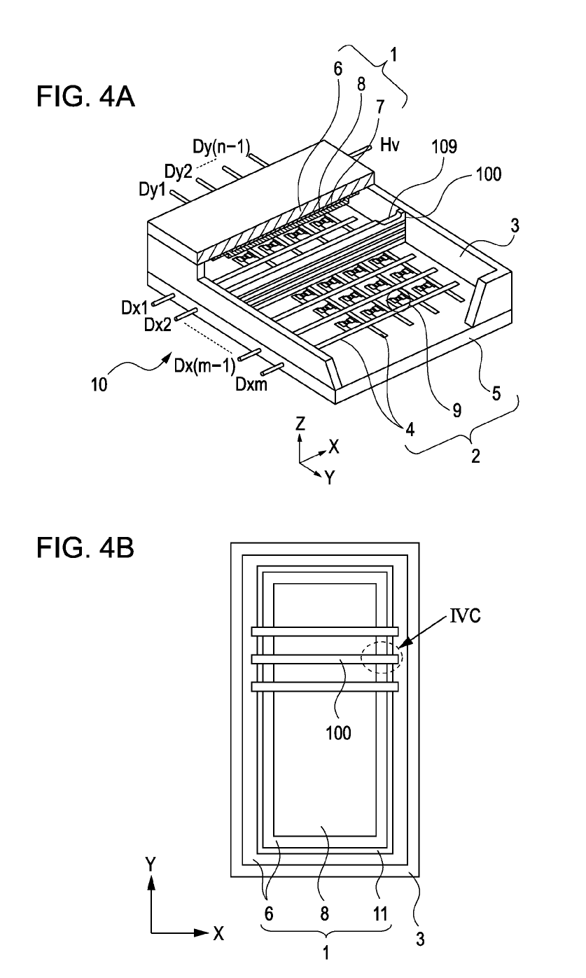

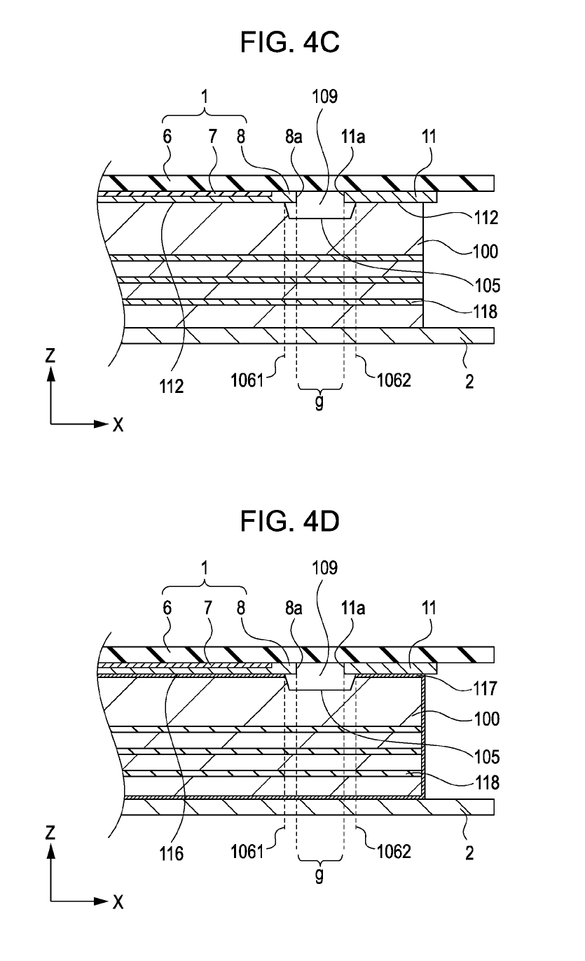

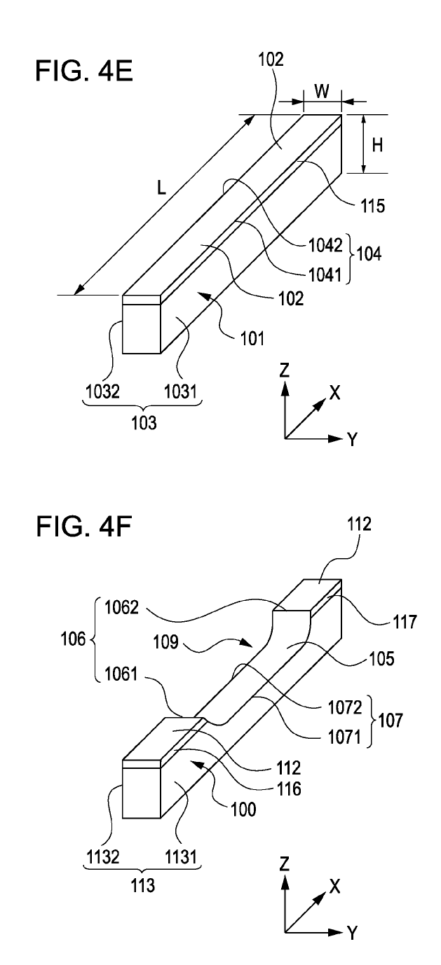

Referring to FIG. 4A, a display device 10 includes a face plate 1 that forms a display surface and a rear plate 2 that is disposed so as to face the face plate 1. A spacer 100 is disposed between the face plate 1 and the rear plate 2. The spacer 100 is a brittle member having a notch, which is by using the method described above. The spacer 100 is hard and sufficiently strong, and thereby functions as a supporting member between the face plate 1 and the rear plate 2. A support frame 3 is disposed between the face plate 1 and the rear plate 2. The face plate 1, the rear plate 2, and the support frame 3 form a vacuum vessel. The face plate 1 and the support frame 3, and the rear plate 2 and the support frame 3 are respectively joined to each other with a bonding material such as frit glass.

The face plate 1 includes a first insulating substrate 6 that is transparent, a fluorescent film 7 that is disposed on the first insulating substrate 6, and an anode electrode 8 that is disposed so as to cover the fluorescent film 7. The fluorescent film 7 is a light-emitting member that functions as a display material. An anode potential Va is supplied to the anode electrode 8 from a high-voltage terminal Hv.

The rear plate 2 includes a second insulating substrate 5, wiring 4 that is disposed on the second insulating substrate 5, and electron-emitting devices 9 connected to the wiring 4. The electron-emitting devices 9 are connected to the wiring 4, which is single-matrix wiring including X-direction wiring Dx1 to Dxm and Y-direction wiring Dy1 to Dyn. As the electron-emitting devices 9, various types of cold cathode devices including a surface conduction type, a Spindt-type, a CNT-type, and an MIM-type are used.

Electron beams emitted by the electron-emitting devices 9 are accelerated by the anode potential Va supplied to the anode electrode 8, and phosphors of the fluorescent film 7 emit light by being irradiated with the electron beams. The anode potential Va is in the range from +1 kV to +50 kV, and typically is +10 kV. The anode electrode 8 also functions as a metal back that increases the light utilization ratio by reflecting a part of light that is reflected from the fluorescent film 7.

As described above, the spacer 100 is made by exfoliating a fraction of the brittle material 101, and the spacer 100 has the notch 109. Japanese Patent Laid-Open No. 2000-311608 discloses a method that can be used to make the brittle material 101 for use as a spacer. That is, the brittle material 101 can be made by heating and drawing a base material to form the shape of the brittle material 101. When “a heating and drawing method” is used, a tensile stress generated in the brittle material 101 is lower than the tensile stress that is generated when a sheet material is cut, so that generation of unwanted cracks is suppressed and notching can be appropriately performed. The notch 109 can be formed at an appropriate position of the spacer 100 in accordance with the shapes of the face plate 1 and the rear plate 2. For example, the notch 109 can be formed at a position at which the spacer 100 straddles members of the display device, such as the electron-emitting devices 9 and the wiring 4. Alternatively, the members of the display device may contact the exfoliated surface 105 of the notch 109. There is almost no projections and burrs around the notch 109 of the spacer 100 made by using the method described above. Dust is not generated by a large amount during notching, with the exception of the exfoliated piece 110. Therefore, it is unlikely that foreign substances (so-called particles) are generated from chips, which are broken off the projections and burrs, and dust, which adheres to the spacer during notching. Therefore, the probability of abnormal discharge or shortage due to the foreign substances can be decreased.

Next, an example of application of the spacer 100 to the display device 10 will be described. FIG. 4B is a plan view of the face plate 1. The face plate 1 includes a low potential electrode 11 that is disposed so as to surround the anode electrode 8 and separated from the anode electrode 8. As a result, a gap g is formed between the anode electrode 8 and the low potential electrode 11. The low potential electrode 11 has a potential Vr that is lower than the anode potential Va. The low potential electrode 11 can have a ground potential. Grooves 118 are formed in the unexfoliated side face 113 of the spacer 100 in order to prevent the spacer 100 from being charged, so that the unexfoliated side face 113 is not even.

FIG. 4C is an enlarged cross sectional view of a region IVC surrounded by a dotted line of FIG. 4B. In the example illustrated in FIG. 4C, the notch 109 faces the gap g. That is, the exfoliated surface 105 faces the first insulating substrate 6 that is exposed between the anode electrode 8 and the low potential electrode 11.

Thus, by disposing the spacer 100 so that the notch 109 faces the gap g, the space surrounding the gap g can be increased. By increasing the space, the magnitude of an electric field formed among the anode electrode 8, the low potential electrode 11, and the spacer 100 by the anode potential Va and the lower potential Vr can be decreased. Moreover, the creepage distance in the vicinity of the gap g can be increased. Therefore, discharge in the vicinity of the gap g can be suppressed.

If there is a portion having an angle smaller than 75° in the vicinity of the notch 109 of the spacer 100, the electric field may concentrate on the portion and may cause a discharge. Therefore, the angle θ between the exfoliated surface 105 and the unexfoliated predetermined face 112 and the angle φ between the exfoliated surface 105 and the unexfoliated side face 113 can be equal to or larger than 75°. That is, the notch 109 can be formed by using a method of irradiation with the beam 201 as described using the FIGS. 3B, 3C, 3G, and 3H.

The face plate 1 is in contact with the spacer 100. However, small gaps may be generated between the face plate 1 and the spacer 100. To be specific, small gaps between the face plate 1 and the spacer 100 may be generated between the anode electrode 8 and the unexfoliated predetermined face 112 of the spacer 100 and between the low potential electrode 11 and the unexfoliated predetermined face 112 of the spacer 100. An intense electric field may be generated in such small gaps and may cause a discharge. There are almost no projection on the unexfoliated predetermined face 112 in the vicinity of the notch 109 of the spacer 100 made by using the method according to the present invention. Moreover, there are almost no round portions in the unexfoliated predetermined face 112 in the vicinity of the notch 109. Therefore, the number of small gaps that may be generated between the face plate 1 and the spacer 100 can be reduced as far as possible, whereby discharge between the face plate 1 and the spacer 100 can be suppressed.

As illustrated in FIG. 4C, an edge portion 8a of the anode electrode 8 and an edge portion 11a of the low potential electrode 11, which face each other, can be located inside the notch 109. That is, the edge portion 8a is closer to the edge portion 11a than the first end ridge 1061, and the edge portion 11a is closer to the edge portion 8a than the second end ridge 1062. In other words, the notch 109 is formed so that the edge portion 8a of the anode electrode 8 and the edge portion 11a of the low potential electrode 11 are exposed. While the edge portion 8a and the edge portion 11a are being formed, projections (burrs) may be generated on the edge portion 8a and the edge portion 11a. However, by disposing the edge portion 8a and the edge portion 11a inside the notch 109, generation of small gaps due to the protrusions can be suppressed.

Referring to FIG. 4D, the surfaces of the spacer 100 that are respectively in contact with the anode electrode 8 and the low potential electrode 11 can be conductive. To be specific, a first electrically conductive film 116 and a second electrically conductive film 117 are disposed on surfaces that contact the anode electrode 8 and the low potential electrode 11, respectively. Thus, the anode potential Va and the potential Vr are reliably applied to the spacer 100. Therefore, discharge between the face plate 1 and the spacer 100 can be suppressed. The second electrically conductive film 117 extends from the unexfoliated predetermined face 112 to the opposite face of the spacer 100. The second electrically conductive film 117 is connected to an electrode (not shown) disposed on the rear plate 2 and having the potential Vr.

Referring to FIG. 4E, the spacer 100 including the first electrically conductive film 116 and the second electrically conductive film 117 can be formed by disposing an electrically conductive film 115 on the predetermined face 102 of the brittle material 101. When making the brittle material 101 by heating and drawing, the electrically conductive film 115 may be disposed on the base material that has not been heated and drawn, or may be disposed on the brittle material 101 that has been heated and drawn. Referring to FIG. 4F, by irradiating the electrically conductive film 115 and/or the brittle material 101 with the beam 201 and thereby exfoliating a fraction of the brittle material 101 and a fraction of the electrically conductive film 115 from the brittle material 101, the electrically conductive film 115 can be split into a first electrically conductive film 116 and a second electrically conductive film 117. The electrically conductive film 115 may be formed by, for example, a metal, an alloy, a metal oxide, or a metal nitride. When the thickness of the electrically conductive film 115 is equal to or smaller than 1/10 and in particular equal to or smaller than 1/100 of the depth of the notch to be made, even if the electrically conductive film 115 is made of an unbrittle substance such as a metal, notching can be performed as in the case when the entirety of the brittle material 101 is made of a brittle substance. For example, in order to form the notch 109 having a depth of 100 μm, if the thickness of the electrically conductive film 115 is equal to or smaller than 10 μm, the presence of the electrically conductive film 115 does not considerably affect notching. In order that the beam 201 can pass through the electrically conductive film 115, the thickness of the electrically conductive film 115 can be equal to or smaller than 1 μm. The absorption constant of the electrically conductive film 115 with respect to the wavelength of the beam 201 can be lower than the absorption constant of the brittle material 101. Although not illustrated in FIGS. 4E and 4F, the grooves 118 can be formed in the side face 103 of the brittle material 101 (workpiece) beforehand.

A high-resistance film, which is well-known, may be disposed on the unexfoliated side face 113 of the spacer 100. The high-resistance film may be formed on the brittle material 101 before the notch 109 is formed, or may be formed on the brittle member 100 after the notch 109 has been formed.

### Example 1

A glass plate having a length L of 1000 mm, a width W of 0.2 mm, and a height H of 1.5 mm was prepared as the brittle material 101 illustrated in FIG. 1A. To be specific, a glass plate, which had been made by heating and drawing a plate of PD200 (made by Asahi Glass Company, Ltd.) having a side face in which grooves were formed with a pitch of 100 μm and by cutting the extended plate into predetermined length (L), was used. Therefore, a large number of fine grooves, which corresponded to the grooves in the glass plate, were formed in the side face 103 of the brittle material 101. The predetermined face 102 of the brittle material 101 had the length L of 1000 mm and the width W of 0.2 mm. The predetermined face 102 was sufficiently smooth. The heat conductivity λ of PD200 at room temperature was 0.92 [W/(m·K)], the specific heat capacity Cₚ was 6.8×10² [J/(kg·K)], the density ρ was 2.8×10³ [kg/m³], and the thermal diffusivity α was 4.8×10⁻⁷ [m²/s].

As illustrated in FIG. 2 C, the brittle material 101 was fixed using the first fixing jig 301 and the second fixing jig 302 that were configured to clamp the brittle material from the predetermined face 102 side and the opposite face side. To be specific, a position on the brittle material 101 that was at a distance of 1.4 mm from an end of the brittle material 101 in the longitudinal direction was clamped using the first fixing jig 301 from the predetermined face 102 side and the opposite face side with a force of 300 gf. Likewise, a position on the brittle material 101 that was at a distance of 9.4 mm from an end the brittle material 101 in the longitudinal direction was fixed using the second fixing jig 302.

In order to prevent the brittle material 101 from being scratched at the contact portions 311 between the jig and the brittle material 101, a material made of PPS resin was used for the contact portions 311 of the first fixing jig 301 and the second fixing jig 302.

Next, the heating step was performed by irradiating the predetermined face 102 of the brittle material 101 with a laser beam. The length Ls of the irradiation area 222 was 4.0 mm, which was the distance between a position on the brittle material 101 that was distanced from an end in the longitudinal direction by 3.4 mm and a position on the brittle material 101 that was distanced from an end in the longitudinal direction by 7.4 mm. A CO₂ laser was used as the light source. The light source emitted a laser beam having a wavelength λ of 10.6 μm, a diameter of 2.0 mm, an output power of 20 W, and a pulse duty of 80%. The beam diameter of the emitted laser beam was expanded to about 8 mm by using a beam expander having a magnification of 4 times, and the laser beam was guided through a galvano mirror and a focusing lens so that the beam diameter was decreased to 220 μm. At this time, the beam width Wb of the beam 201 was about 10% larger than the width (0.2 mm) of the predetermined face 102. The beam 201 had a circular shape as illustrated in FIG. 3F, which was about the same as the original shape of the emitted beam. The energy intensity distribution in the spot 202 was a Gaussian distribution illustrated in FIG. 3A, and the difference between the maximum value and the minimum value was about 90% of the maximum value. The energy density of the beam 201, which was approximately inversely proportional to the square of the magnification of the diameter of the beam 201 relative to the diameter of the emitted beam, was about 80 times the energy density of the emitted beam. The galvano mirror was rotated so that the spot 202 could scan the predetermined face 102 at the speed of 100 [m/s]. The predetermined face 102 was irradiated with the beam 201, and the spot 202 was scanned in the X direction by 4.0 mm. It was confirmed that the irradiation area 222 irradiated with the beam 201 was melted.

Next, the cooling step was performed to cool the brittle material 101. Natural cooling at room temperature was used. The high-temperature portion 108 contracted due to cooling, and a stress was generated at the boundary between the high-temperature portion 108 and the low-temperature portion. As a result, a crack was generated due to delayed fracture. The crack was generated at the boundary between the high-temperature portion 108 and the low-temperature portion on the side edge 104 of the brittle material 101. The crack grew along the boundary between the high-temperature portion 108 and the low-temperature portion. In the periphery of the irradiation area 222 scanned by the spot 202, the exfoliated piece 110 having a length (in the X direction) of about 4 mm, a width (in the Y direction) of 200 μm, and the maximum depth (the Z direction) of about 100 μm was generated. Accordingly, the notch 109 having the same shape as the exfoliated piece 110 was formed.

As illustrated in FIG. 3A, the angle between the end ridge 106 and the unexfoliated side face 113 was about 45°. The exfoliated surface 105 was characterized in that the surface roughness Ra at the center or the exfoliated surface 105 was about 0.5 μm, which was smaller than that of the unexfoliated side surface 113, and the exfoliated surface 105 was almost glossy.

### Example 2

In the cooling step of EXAMPLE 1, forced cooling was performed using liquid nitrogen. A nozzle of a liquid nitrogen supplying apparatus was directed to the predetermined face 102 and liquid nitrogen was dropped. The dropped amount was about 1 cc so that the liquid nitrogen did not flow down along the side face 103 of the brittle material 101. Because liquid nitrogen evaporated in a short time, irradiation with the beam 201 and scanning of the beam 201 were performed before the liquid nitrogen evaporated. The heating step was performed in the room temperature atmosphere, and scanning was started 0.1 to 0.2 seconds after the liquid nitrogen had been dropped and the scanning was finished in 0.1 seconds. In EXAMPLE 2, the probability of exfoliation was higher than that of EXAMPLE 1, and the yield improved.

### Example 3

After the laser irradiation in EXAMPLE 1, as illustrated in FIG. 2G, the second fixing jig 302 was removed from the opposite face of the brittle material 101 and fixing was released. Then, as illustrated in FIG. 2D, the second fixing jig 302 was moved to a position that was distanced from the high-temperature portion 108 by 30 mm, and the brittle material was fixed again as illustrated in FIG. 2H. Subsequently, as illustrated in FIG. 2B, a stress in the counter-warping direction was applied to the brittle material 101. To be specific, as illustrated in FIG. 2E, the opposite face was pushed by about 1 mm from a side opposite to the predetermined face 102 (opposite face side) by using the opposite-direction warping jig 303. As the opposite-direction warping jig 303, an arm having a contact portion made of a PPS resin was used. In EXAMPLE 3, the probability of exfoliation was higher than that of EXAMPLE 2, and the yield improved.

### Example 4

In the cooling step of EXAMPLE 3, forced cooling was performed as in EXAMPLE 2. As a result, the probability of exfoliation was higher than that of EXAMPLE 3, and the yield improved.

### Example 5

In EXAMPLE 1, the brittle material 101 was fixed by using only the second fixing jig 302 and without using the first fixing jig 301, and the same process as that of EXAMPLE 1 was performed. As a result, the precision was lower than that of EXAMPLE 1.

### Example 6

Instead of the brittle material 101 used in EXAMPLE 5, the brittle material 101 having a height H of 10 mm was prepared and the same process was performed. As a result, the probability of exfoliation and the precision ware higher than those of EXAMPLE 5. This was presumably because the degree of warping decreased due to the increase in the height H of the brittle material 101.

### Comparative Example 1

In EXAMPLE 1, the width of the beam 201 was decreased to 120 μm so as to form a spot having a width of 120 μm in the Y direction at the center of the predetermined face 102, and the spot was scanned in the X direction. At this time, a spot was not formed on the side edges 104 of the predetermined face 102. In other respects, COMPARATIVE EXAMPLE 1 was the same as EXAMPLE 1.

Notching was performed on ten brittle materials 101, and only one of them was exfoliated. Moreover, the shape of the exfoliated surface 105 was considerably different from the shape of the irradiation area 222, which was unsymmetrical with respect to the Y direction.

### Comparative Example 2

In EXAMPLE 1, the width of the beam 201 was decreased to 120 μm so as to form a spot having a width of 110 μm on the predetermined face 102 in the Y direction from one of the side edges 104, and the spot was scanned in the X direction. Next, the brittle material 101 was moved in the Y direction by 110 μm, a spot was formed on the predetermined face 102 so as to have a width from the other of the side edges 104 in the Y direction by a width of 110 μm, and the spot was scanned in the same X direction. In other respects, COMPARATIVE EXAMPLE 2 was the same as EXAMPLE 1.

Notching was performed on ten brittle materials 101, and only two of them were exfoliated. Moreover, the shapes of the exfoliated surfaces 105 of the two brittle materials 101 were different from each other.

### Example 7

In the heating step of EXAMPLE 4, a mask having a rectangular opening was disposed between the beam expander and the galvano mirror so as to make the shape of the spot 202 formed on the predetermined face 102 is substantially rectangular as illustrated in FIG. 3G. To be specific, the magnification of the beam expander was ten times, the diameter of the beam incident on the mask was 20 mm, and the beam was made to pass through the opening that was 8 mm per side. The energy density of the beam decreased when the magnification of the beam expander increased. In order to compensate for the decrease, the output power of the laser oscillator was set to 120 W. The difference between the maximum value and the minimum value of the energy intensity distribution of the spot 202 on the predetermined face 102 was about 30% of the maximum value. A spot that was 220 μm per side was formed by using the focusing lens that was the same as that of EXAMPLE 1. The galvano mirror that was the same as that of EXAMPLE 1 was used. The speed of scanning the spot was 100 [m/s], which was the same as that of EXAMPLE 1, and the beam was scanned by 4.0 mm. As a result, the notch 109 having a depth of about 100 μm was formed as in EXAMPLE 1. The angle φ between the end ridge 106 and the side face 103 was about 85°.

### Example 8

In the heating step of EXAMPLE 4, a mask having an hourglass-shaped opening was disposed between the beam expander and the galvano mirror so as to form the spot 202 having an hourglass shape as illustrated FIG. 3H on the predetermined face 102. To be specific, the opening of the mask had the maximum width of 8 mm in the X direction and in the Y direction of the spot 202, and had a width of 6 mm in the X direction at a central portion having a length of 1 mm. The magnification of the beam expander was ten times, the diameter of the beam incident on the mask was 20 mm, and the beam was made to pass through the opening of the mask. The energy density of the beam 201 decreased when the magnification of the beam expander increased. In order to compensate for the decrease, the output power of the laser oscillator was set to 120 W. The focusing lens that was the same as that of EXAMPLE 1 was used. The spot 202 having a shape that was similar to that of the mask and that was 220 μm per side was formed. The galvano mirror the same as that of EXAMPLE 1 was used. The speed of scanning the spot was 100 [m/s], which was the same as that of EXAMPLE 1, and the beam was scanned by 4.0 mm. As a result, the notch 109 having a depth of about 100 μm was formed as in EXAMPLE 1. The angle φ between the end ridge 106 and the side face 103 was about 100°.

### Example 9

In the heating step of EXAMPLE 7, the energy intensity distribution of the spot 202 on the predetermined face 102 was made to be flat as illustrated in FIG. 3B. A beam homogenizer was disposed between the beam expander and the mask so as to achieve an energy intensity distribution having a range equal to or smaller than 5%, which could be regarded as flat. The beam homogenizer had an optical system that included an aspherical lens and a diffraction grating and that was designed so as to convert the energy distribution from a Gaussian distribution to a flat distribution whose difference between the maximum value and the minimum value was equal to or smaller than 5% of the maximum value. By adjusting the beam diameter of a beam that was incident on the beam homogenizer, a flat energy intensity distribution could be obtained. The beam diameter of a beam that was incident on the beam homogenizer was adjusted by changing the magnification of the beam expander. When the beam diameter changed, the energy intensity of the beam that was incident on the mask changed. In order to compensate for the change, the output power of the laser oscillator was adjusted. In EXAMPLE 9, the angle θ was about 90° as illustrated in FIG. 3B, and the surface roughness Ra of the exfoliated surface 105 in the Y direction was 0.5 μm.

### Example 10

In the heating step of EXAMPLE 7, as illustrated in FIG. 3C, the energy intensity distribution in the spot was made to have a distribution such that the energy intensity have the minimum value at the center of the predetermined face in the lateral direction. For this purpose, a beam homogenizer was disposed between the beam expander and the mask. By making the beam diameter of a beam that was incident on the beam homogenizer to be larger than a desired value, the energy at the center of the beam could be made smaller than that in the peripheral area. The beam diameter of a beam that was incident on the beam homogenizer was adjusted by changing the magnification of the beam expander. When the beam diameter changed, the energy intensity of the beam that was incident on the mask changed. In order to compensate for the change, the output power of the laser oscillator was adjusted. The difference between the maximum value and the minimum value of the energy intensity distribution in the spot 202 on the predetermined face 102 was about 50% of the maximum value. In EXAMPLE 10, as illustrated in FIG. 3C, the exfoliated surface 105 having a convex shape in the YZ cross section was obtained, and the angle θ was about 110°.

### Example 11

The brittle member made in one of EXAMPLES 4 and 7 to 10 was used as a spacer, and the display device 10 illustrated in FIGS. 4A to 4F was made.

First, the face plate 1 illustrated in FIGS. 4A and 4B and the rear plate 2 illustrated in FIG. 4A were made. The gap g between the anode electrode 8 and the low potential electrode 11 of the face plate 1 illustrated in FIG. 4B was 4 mm. The electron-emitting devices 9 disposed on the rear plate 2 were surface-conduction-type electron-emitting devices. At appropriate positions of the rear plate 2, the spacers 100, which were the brittle members made in EXAMPLE 4, were disposed upright on the rear plate 2 so that the opposite faces thereof were on the rear plate 2 side and so that the spacers 100 extended parallel to one another. The support frame 3 was disposed on the rear plate 2. The face plate 1 and the rear plate 2, on which the spacers 100 and the support frame 3 were disposed, were placed in a vacuum chamber and the vacuum chamber was evacuated. After the vacuum chamber had been sufficiently evacuated, the positions of the face plate 1 and the rear plate 2 were adjusted, and the face plate 1 and the rear plate 2 were stacked and sealed. The edge portion 8a of the anode electrode 8 and an edge portion 11a of the low potential electrode 11 were disposed at positions that coincided with the end ridge 106 of the notch 109 of the spacer 100. Thus, the display device 10 was made. In the same manner, the display device 10 was made by using the brittle member made in each of EXAMPLES 8 to 11.

A power supply capable of applying a voltage of 5 kV or higher was connected to the high-voltage terminal Hv of the display device 10. The low potential electrode 11, the X-direction wiring, and the Y-direction wiring were grounded. The power supply was switched ON so that 10 kV was applied to the high-voltage terminal Hv, and the display device 10 was observed for twelve hours. In any of the display devices in which the brittle members made in EXAMPLES 4 and 8 to 11 were used as the spacers 100, discharge was not observed.

The applied voltage was increased from 15 kV by 1 kV per hour. In the display device using the spacer 100 made in EXAMPLE 4, discharge did not occur below 17 kV. In the display device using the spacer 100 made in EXAMPLES 7 and 9, discharge did not occur below 19 kV. In the display device using the spacer 100 made in EXAMPLES 8 and 9, discharge did not occur below 20 kV.

### Comparative Example 3

Spacers were made by grinding the brittle material 101 prepared in EXAMPLE 1 using a diamond grindstone so as to form a notch having a length (in the X direction) of about 4 mm, a width (in the Y direction) of about 200 μm, and the maximum depth (in the Z direction) of about 100 μm. By using the spacers, the display device 10 was made in the same manner as in EXAMPLE 11. The display device 10 was less resistant to discharge than the display device using the spacers 100 made in EXAMPLE 4.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2009-236433, filed Oct. 13, 2009 and No. 2010-206729 filed Sep. 15, 2010, which are hereby incorporated by reference herein in their entirety.

What is claimed is:

1. A method of notching a brittle material, the method comprising:
heating the brittle material by forming a light beam spot on a predetermined face of the brittle material by irradiating an area of the predetermined face with a light beam; and
forming a notch in the brittle material by exfoliating a fraction of the brittle material including the area from the brittle material by cooling a portion of the brittle material including the area after the heating the brittle material,
wherein a length of the area in a longitudinal direction of the predetermined face is smaller than a total length of the predetermined face in the longitudinal direction, and a length of the light beam spot in a lateral direction of the predetermined face is equal to a total length of the predetermined face in the lateral direction.

2. The method according to claim 1,
wherein a beam diameter of the light beam in the lateral direction is larger than the total length of the predetermined face in the lateral direction.

3. The method according to claim 1,
wherein the total length of the predetermined face in the lateral direction is smaller than the length of the area in the longitudinal direction and smaller than a total length of the brittle material in a direction perpendicular to the predetermined face.

4. The method according to claim 1,
wherein, in the heating the brittle material, a length of the light beam spot in the longitudinal direction is smaller than the length of the area in the longitudinal direction, and the light beam spot is scanned in the longitudinal direction.

5. The method according to claim 4,
wherein the light beam spot is scanned in such that a time interval between a time when the light beam spot that forms one edge of the area is formed and a time when the light beam spot that forms the other edge of the area is formed, the one and other edges intersecting to the longitudinal direction, is approximately equal to or smaller than Ls²/4α [s], where Ls [m] is the length of the area in the longitudinal direction and α [m²/s] is a thermal diffusivity of the brittle material.

6. The method according to claim 1,
wherein an absorption constant of the brittle material with respect to a wavelength of the light beam is approximately equal to or larger than 20.

7. The method according to claim 1,
wherein the brittle material is made of a silicate glass, and a wavelength of the light beam is approximately equal to or larger than 4 μm.

8. The method according to claim 1,
wherein the heating and the forming are performed when at least two positions of the predetermined face in the longitudinal direction are fixed, and in the heating, the light beam spot is formed between the two positions.

9. The method according to claim 1,
wherein, in the forming the notch, a bending stress that warps the predetermined face to have a convex shape is applied to the brittle material.

10. The method according to claim 1,
wherein a conductive film is disposed on the predetermined face of the brittle material, and by performing the forming the notch, the conductive film is split into a plurality of conductive films that are arranged in the longitudinal direction with the notch therebetween.

11. A method of making a member having a notch, the method comprising:
preparing a brittle material; and
forming the notch in the brittle material by using the method according to claim 1.

12. The method according to claim 11,
wherein the brittle material is made by using a heating and drawing method.

13. A method of making a display device, the method comprising:
making a spacer having a notch by using the method according to claim 11; and
disposing a face plate, a rear plate, and the spacer in such a manner that the face plate faces the rear plate with the spacer therebetween and the face plate constitutes a display surface.

14. The method according to claim 13,
wherein the rear plate includes an electron-emitting device,
wherein the face plate includes a fluorescent film, an anode electrode stacked on the fluorescent film, and a low potential electrode facing the anode electrode with a gap therebetween, the anode electrode being set to a potential higher than a potential of the electron-emitting device, and the low potential electrode being set to a potential lower than the potential of the anode electrode, and
wherein, the disposing the face plate, the rear plate, and the spacer is performed so that the spacer is connected to the anode electrode and the low potential electrode and so that the notch faces the gap.

15. A method of making a member having a notch, the method comprising:
preparing a brittle material; and
forming a notch in a brittle material by using the method according to claim 3.

16. A method of making a display device, the method comprising:
making a spacer having a notch by using a method according to claim 15; and
disposing a face plate, a rear plate, and the spacer such that the face plate faces the rear plate with the spacer therebetween, the face plate forming a display surface.
